(19) United States
(12) Patent Application Publication
(10) Pub. No.: US 2007/0125137 A1
(43) Pub. Date: Jun. 7, 2007

(54) Security device for a computer system

(75) Inventor: Steve Galant, Kleinburg (CA)

Correspondence Address: CAESAR, RIVISE, BERNSTEIN,;COHEN & POKOTILOW, LTD., 11TH FLOOR, SEVEN PENN CENTER, 1635 MARKET STREET, PHILADELPHIA, PA, 19103-2212, US

(73) Assignee: Compucage International Inc., Ontario (CA)

(21) Appl. No.: 11/292,239

(22) Filed: Dec. 1, 2005

(51) Int. Cl. E05B 73/00

(52) U.S. Cl. 70/58

(57) ABSTRACT

A security device for use with an electronic device and a lock is provided. The electronic device has a security slot. The security device comprises a first key having a body portion and a head portion and a second key having a body portion and a head portion. The body portion of the second key is disposed at an angle relative to the head portion of the second key. The body portions of the first key and the second key can be extended through the security slot and the first head portion and the second head portion can be secured together with the lock such that the body portions of the first key and the second key within the computing device diverge to preclude withdrawal of the bodies from the slot.

### FIELD OF THE INVENTION

The present invention relates generally to office equipment security and, more specifically, to locking devices for securing the contents of office equipment devices and/or anchoring office equipment devices to a structure.

### BACKGROUND OF THE INVENTION

The proliferation of microcomputer technology has created tremendous opportunity for criminals, given the high value of office equipment. Government, businesses, insurance companies, and private individuals are all faced with the problem of theft of personal computers, laptops, personal digital assistants, and other types of microcomputer devices, resulting in an unnecessary societal economic burden.

A number of security devices for microcomputers are available in the marketplace. These conventional security devices typically attach to some sort of crevice in the microcomputer, such as a screw hole, disk drive slot, data port, etc. Other security devices employ an anchor, typically made of plastic, attached to the body of the microcomputer with glue. Conventional security devices typically employ a cable to anchor the microcomputer to a desk or other solid structure. These conventional solutions to anchoring microcomputer devices serve more as a deterrent than as a real physical barrier to stealing a microcomputer. Even when conventional security devices for microcomputers are employed, a microcomputer is often still easily stolen, sometimes resulting to damage to the microcomputer and/or the device to which the microcomputer is anchored.

Accordingly, there remains a need for improvements in the art.

### BRIEF SUMMARY OF THE INVENTION

Embodiments of the present invention described hereinafter serve as robust security devices for an electronic device that may be used to securely anchor the electronic device to a fixture and/or lock the electronic device so that components may not be removed from the interior of the electronic device.

A security device for use with an electronic device and a lock forms one aspect of the invention. The electronic device has a security slot. The security device comprises a first key having a body portion and a head portion and a second key having a body portion and a head portion. The body portion of the second key is disposed at an angle relative to the head portion of the second key. The body portions of the first key and the second key can be extended through the security slot and the first head portion and the second head portion can be secured together with the lock such that the body portions of the first key and the second key within the electronic device diverge to preclude withdrawal of the bodies from the slot.

An electronic device security device for use with an electronic device and a lock forms another aspect of the invention. The electronic device has a housing with a security hole formed therein. The electronic device further has an electronic device locking mechanism defining a socket and preventing the electronic device from being opened when the socket is occupied. The electronic device security device comprises a first key having a body portion and a head portion with the body portion being disposed at a first angle relative to the head portion, and a second key having a body portion and a head portion with the body portion being disposed at a second angle relative to the head portion. At least one of the first angle and the second angle is less than 180 degrees. The body portions of the first key and the second key can be extended through the security hole to occupy the socket and the first head portion and the second head portion can be secured together with the lock such that the body portions of the first key and the second key within the electronic device diverge due to the first angle and the second angle to preclude withdrawal of the bodies from the hole.

A security device for use with an electronic device and a lock forms another aspect of the invention. The electronic device has a security slot. The security device comprises a first key having a body portion and a head portion with the body portion of the first key being disposed at a first angle relative to the head portion of the first key. The first key further has a hole located in the head portion sized for receiving a shackle of the lock. The security device further comprises a second key having a body portion and a head portion with the body portion of the second key being disposed at a second angle relative to the head portion of the second key. The second key further has a hole located in the head portion sized for receiving the shackle of the lock. At least one of the first angle and the second angle is less than 180 degrees. The body portions of the first key and the second key can be inserted into the security slot and the shackle can be passed through the holes in the head portions to secure the same together such that the body portions of the first key and the second key within the electronic device diverge due to the angles to preclude withdrawal of the bodies from the slot.

### BRIEF DESCRIPTION OF THE DRAWINGS

Reference will now be made to the drawings, which show exemplary embodiments of the invention, and in which:

FIG. 1 is a perspective view of an office equipment security device in accordance with one embodiment of the present invention;

FIG. 2 is a perspective view of the office equipment security device of FIG. 1 assembled for use;

FIG. 3 is a perspective view of an office equipment security device in accordance with another embodiment of the present invention;

FIG. 4 is a partial perspective view of a personal computer including a security slot;

FIG. 5 is a perspective view of a personal computer having side buttons that release a clamshell style cover;

FIG. 6 is a partial perspective view of the structure of FIG. 5, with the clamshell cover shown open and an interior locking mechanism visible, the locking mechanism being disposed in an unlocked position;

FIG. 7 is an enlarged view of a portion of FIG. 6;

FIG. 8 is a view similar to FIG. 7, showing the locking mechanism in a locked position;

FIG. 9 is a partial perspective view of a portion of the structure of FIG. 6, showing a receiving slot for the locking mechanism; and

FIGS. 10a-e show in perspective view a series of steps involved in installing the office equipment security device of FIG. 1 in the computer of FIG. 5.

In the drawings, like reference numerals denote like elements or features.

### DETAILED DESCRIPTION OF THE EMBODIMENTS

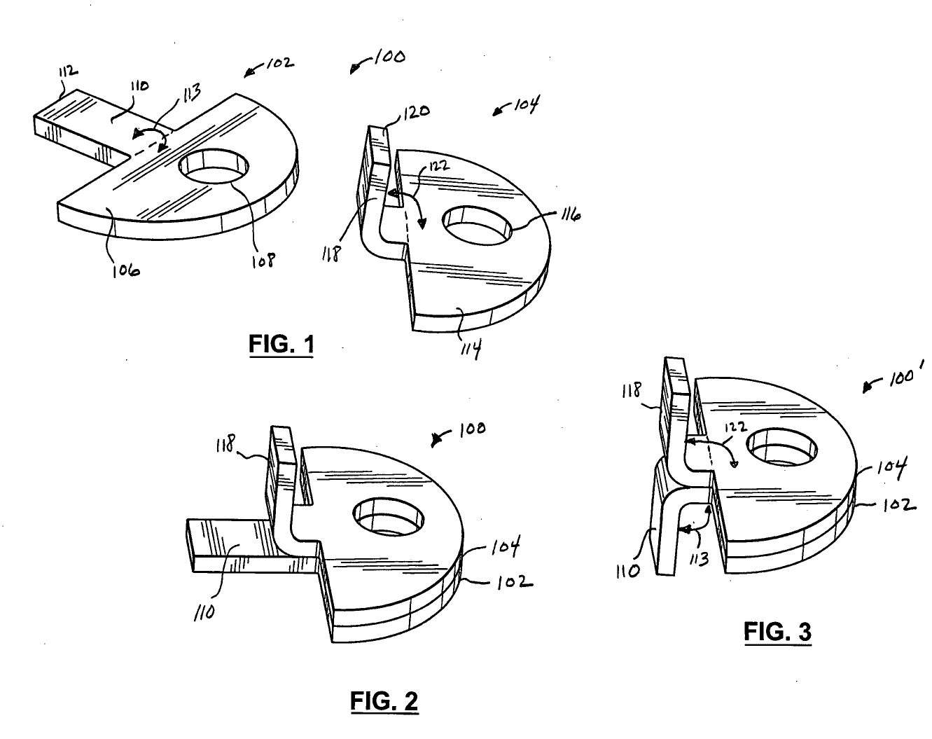

Reference is first made to FIG. 1, which shows a perspective view of an office equipment security device 100 in accordance with one embodiment of the present invention. The office equipment security device 100 includes a first key 102 and a second key 104. The first key 102 generally has a head portion 106 connected to a narrower body portion 110. The head portion 106 has a hole 108 and the body portion 110 has an end 112. The head portion 106 is disposed at an angle 113 relative to the body portion 110. In the exemplary embodiment illustrated in FIG. 1, the angle 113 is 180 degrees, such that the body portion 110 and the head portion 106 lie in a common plane. Similar to the first key 102, the second key 104 generally has a head portion 114 connected to a narrower body portion 118. The head portion 114 has a hole 116 and the body portion 118 has an end 120. The body portion 118 of the second key 104 is disposed at an angle 122 relative to the head portion 114. In this illustrated embodiment, the angle 122 is approximately 90 degrees, as shown in FIG. 1. As such, the body portion 118 is approximately perpendicular to the head portion 114. The keys 102 and 104 are preferably made of metal, but any material may be used so long as it is difficult to bend the body portions 118 and 110 relative to the respective head portions 114 and 106, that is, so that it is difficult to change the angles 113 and 122, subsequent to manufacturing of the keys 102 and 104. The holes 108 and 116 are sized so as to receive the shackle of a suitable padlock. The head portions 106 and 114 are shown as being half circular or semicircular in shape, however any size and shape may be used for the head portions 106 and 114 so long as the head portions 106 and 114 of the keys 102 and 104 are able to have appropriate sized holes 108 and 116 to receive the shackle of the desired padlock.

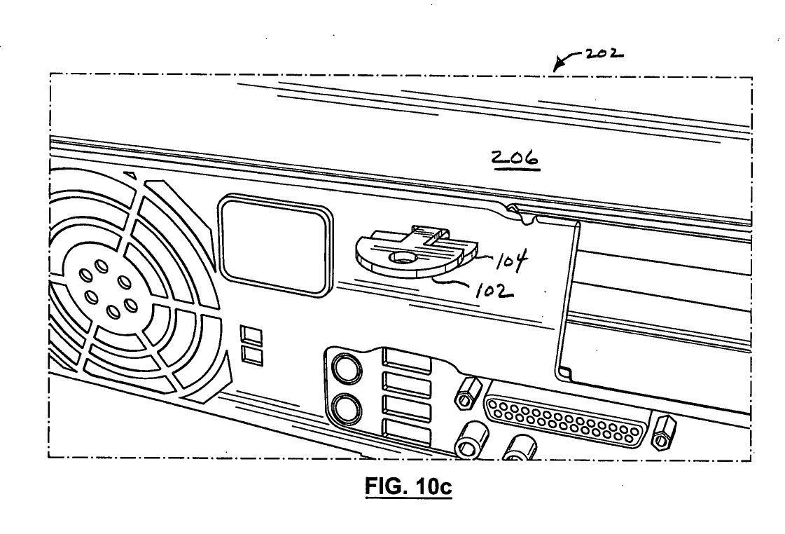

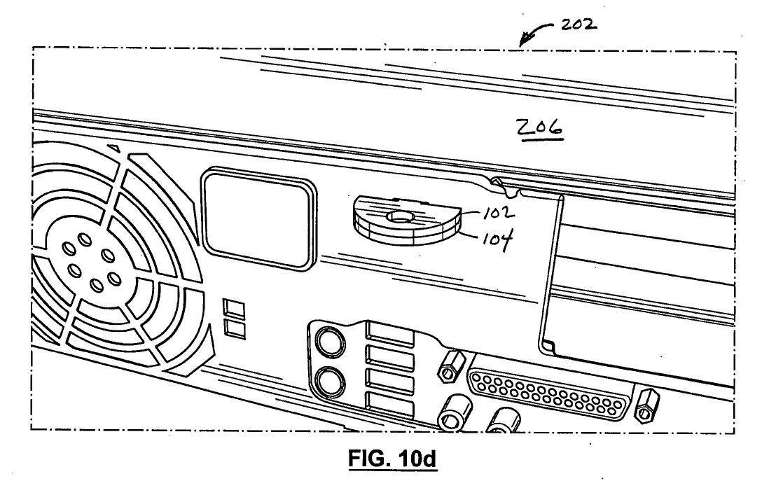

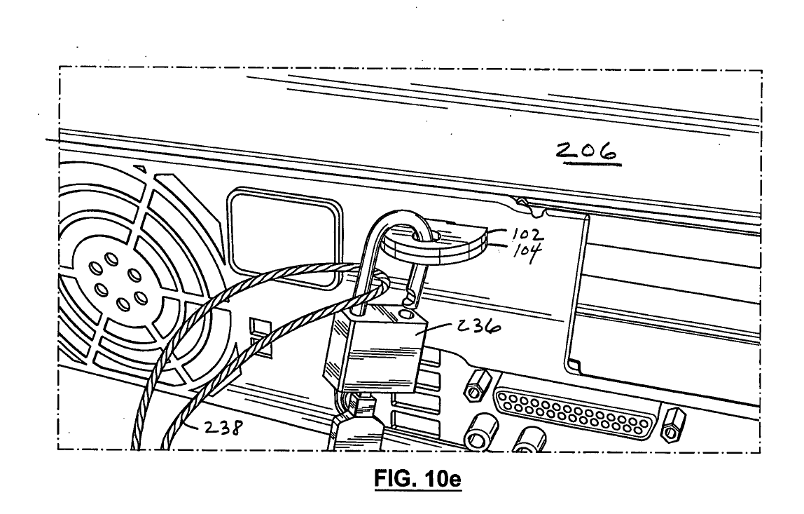

Reference is next made to FIGS. 2 and 4. FIG. 2 shows a perspective view of the office equipment security device 100 of FIG. 1 in an assembled configuration, as it would take once installed in a microcomputer. FIG. 4 shows a perspective view of a typical security slot 200 formed in a personal computer 202. Microcomputer devices (e.g., personal computers and laptop computers) are increasingly, being designed to have a security slot such as the security slot 200. Typical security slots are 0.125×0.275 inches in size, +/−0.01 inches. However, the security device 100 is easily manufactured to be applicable to security slots of any shape and size by changing the shapes and sizes of the body portions 110 and 118, depending on the design criteria of a particular application. In use, the keys 102 and 104 are installed into the security slot 200. First, the body portion 118 of the second key 104 is slid into the security slot 200. As this is being done, the second key 104 is rotated upwards such that head portion 114 of the second key 104 is perpendicular to the back of the personal computer 202 with the body portion 118 protruding towards the interior of the personal computer 202 and pointing downwards. Next, the body portion 110 of the first key 102 is inserted into the security slot 200 above the second key 104 such that the keys 102 and 104 are resting in an orientation that is upside down to the orientation shown in FIG. 2. The shackle of the padlock is attached through the holes 108 and 116 thereby securing the head portions 106 and 114 together. A cable or chain may be attached to the padlock in order to secure the personal computer 202 to a secure structure. The perpendicular orientation of the body portion 118 of the second key 104 to the head portion 114 (i.e., the angle 122 being 90 degrees such that the body portions 110 and 118 diverge) prevents the keys 102 and 104 from being removed or withdrawn from the security slot 200 when the padlock is in place. The installation of the keys 102 and 104 is described in greater detail below with reference to FIGS. 10a-e.

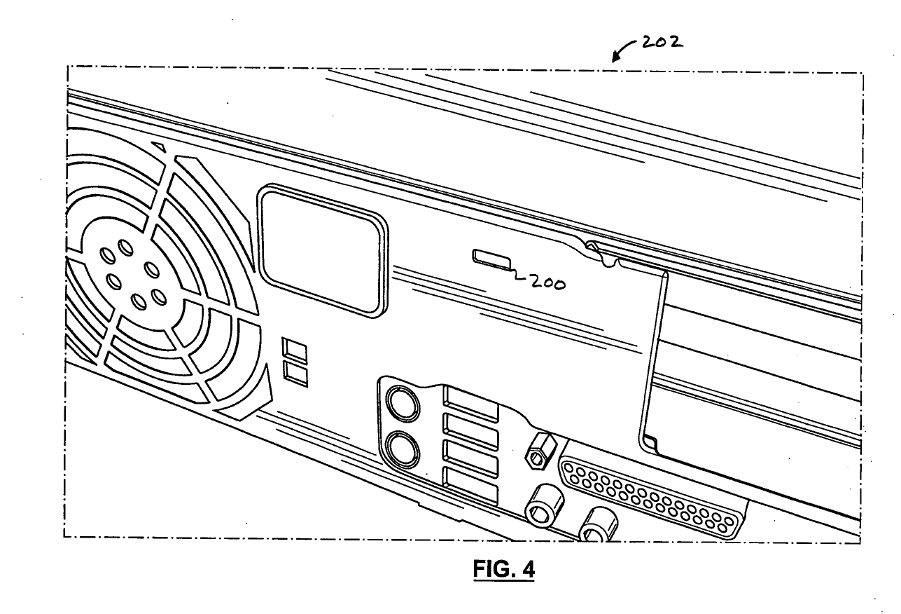

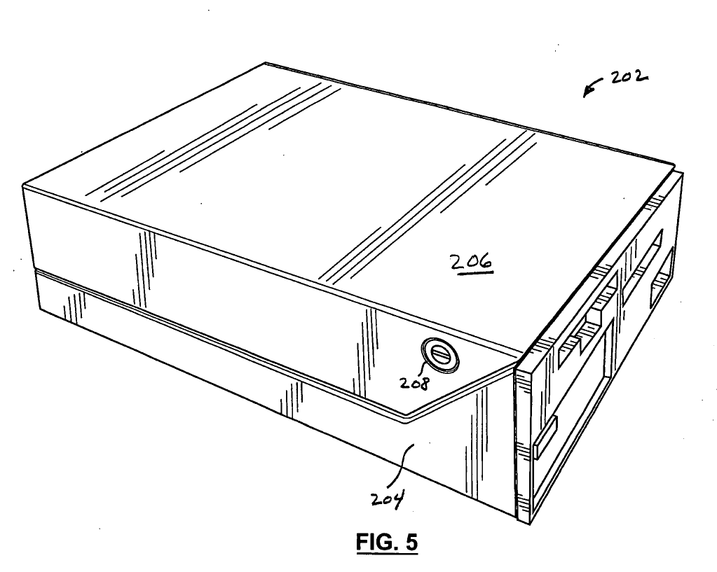

Reference is next made to FIG. 3, which shows a perspective view of an office equipment security device 100′ in accordance with another embodiment of the present invention. The security device 100′, shown in FIG. 3, is the same as shown in FIG. 1, except that the angle 113 is illustrated as being approximately 90 degrees, similar to the angle 122, shown in FIGS. 1 and 3. It will be understood by those skilled in the art that the angles 113 and 122 may be of any value between 180 degrees and approximately 75 degrees, so long as both of the keys 102 and 104 can be inserted into the security slot 200, as discussed above and in relation to FIGS. 10a-e, and the keys 102 and 104 cannot be removed from the security slot 200 when the padlock is in place. Generally, for the keys 102 and 104 to not be removable (i.e., cannot be withdrawn) from the security slot 200 when the padlock is in place, at least one of the angles 113 and 122 should be less than 180 degrees such that the body portions 110 and 118 diverge when the keys 102 and 104 are arranged in the orientation shown in FIGS. 2 and 3.

Reference is now made to FIG. 5, which shows a perspective view of a personal computer 202 having buttons that release a releasable cover. In addition to the security slot 200, the personal computer 202 may have other security features for use with the keys 102 and 104. In one embodiment, the personal computer 202 has a main chassis 204 and a releasable cover 206. The releasable cover 206 is attached to the main chassis 204 with hinges located inside a rear end of the personal computer 202, such that the cover 206 and chassis 204 open in a clamshell manner. The front end of the releasable cover 206 is released by depressing one or more buttons 208. While one button 208 is shown in FIG. 5, the personal computer 202 has a second button located in the same position on the other side of the personal computer 202 (not shown).

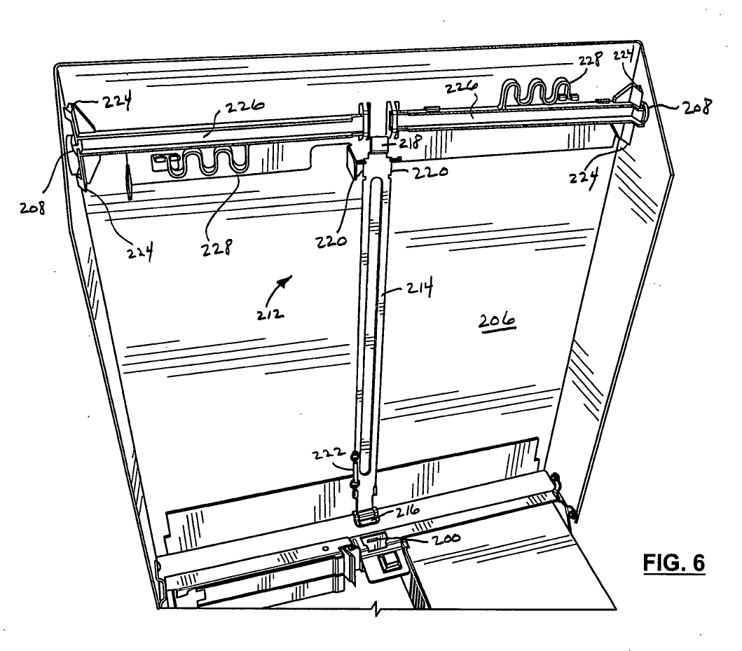

Reference is next made to FIG. 6, which shows a perspective view of a locking mechanism 212. FIG. 6 shows the releasable cover 206 in a raised position, exposing the interior of the personal computer 202. The security slot 200 is seen towards the bottom of FIG. 6. The locking mechanism 212 generally comprises a push rod 214 that is slideably attached to the underside of the releasable cover 206. The push rod 214 has an actuating end 216 that is bent downwards and is approximately perpendicular to the push rod 214. The push rod 214 further has a raised end 218, side portions 220, and an attached biasing spring 222 for retaining the push rod 214 in a rearward position with respect to the releasable cover 206. The locking mechanism 212 further comprises the buttons 208 that are attached to respective locking clips 224, transverse push rod engaging members 226, and coils or springs 228.

In a normal unlocked state, the locking mechanism 212 rests as shown in FIG. 6, when the releasable cover 206 is closed, with the push rod 214 in a rearwardly biased position. The coils 228 retain the transverse push rod engaging members 226, the buttons 208, and the locking clips 224 in their undepressed position, as shown in FIG. 6. In this undepressed position, the locking clips 224 engage cooperating slots or holes (not shown) in the main chassis 204, thereby securing the releasable cover 206 to the chassis 204 in the closed position. When a user depresses the buttons 208, the buttons 208, the locking clips 224, and the push rod engaging members 226 slide towards the centre of the releasable cover 206. The locking clips 224 then no longer engage the cooperating slots or holes in the chassis 204 and the releasable cover 206 may be raised into its open position, as shown in FIG. 6. The push rod 214 does not interfere with the push rod engaging members 226 when the push rod 214 rests in its rearward position, as shown in FIG. 6. Biasing spring 222 biases the push rod 214 towards its rearward position.

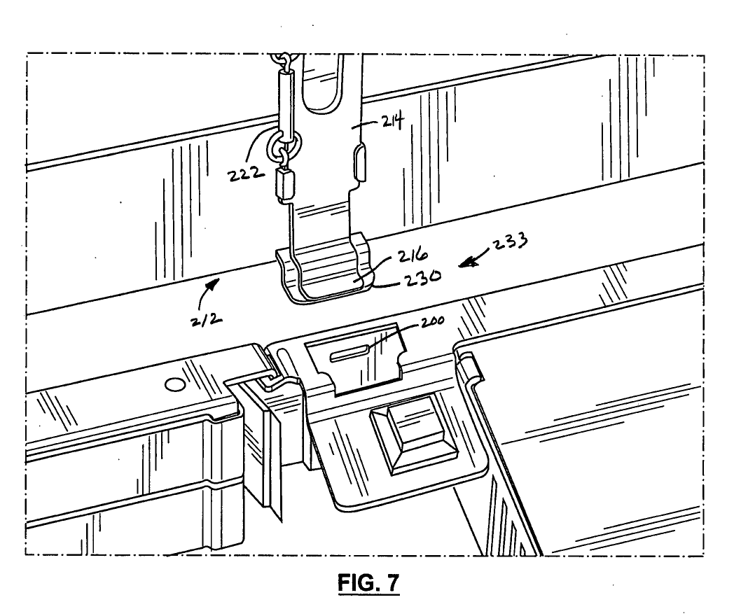

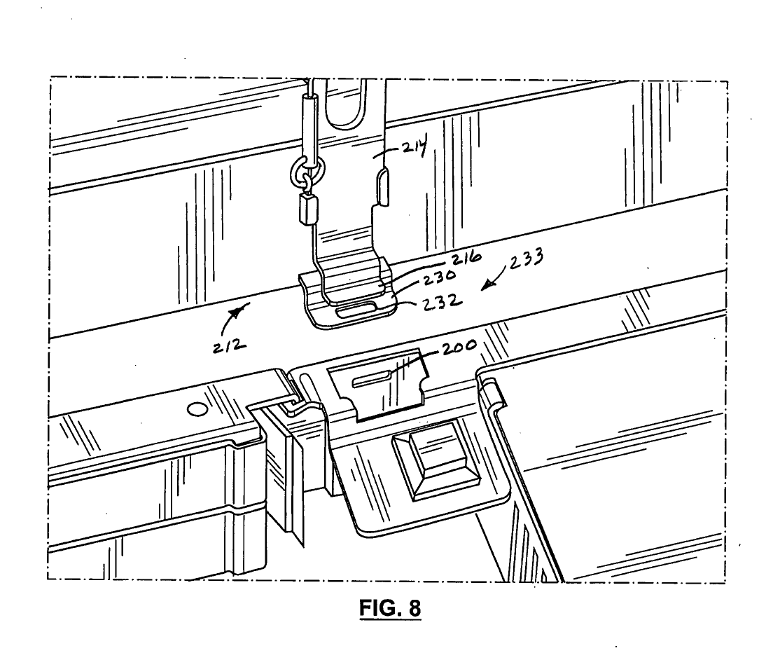

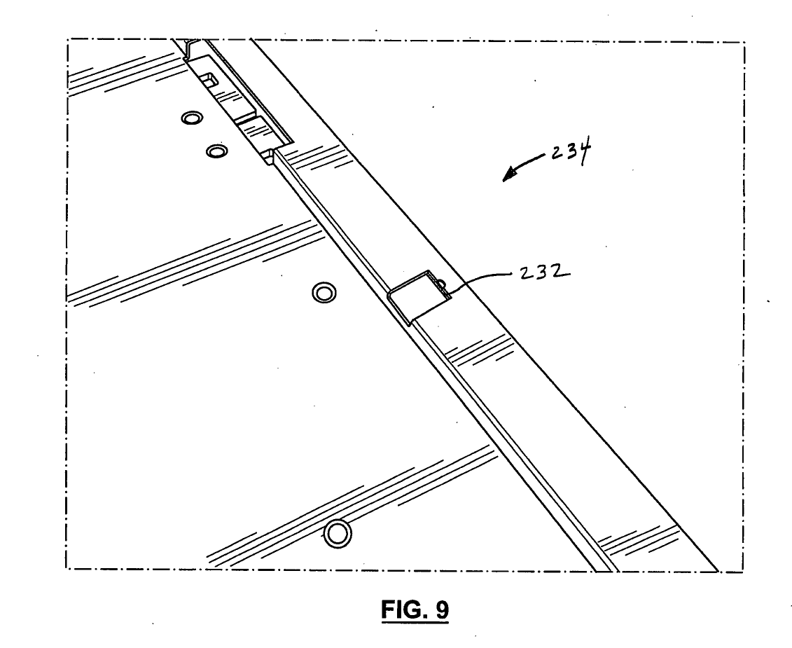

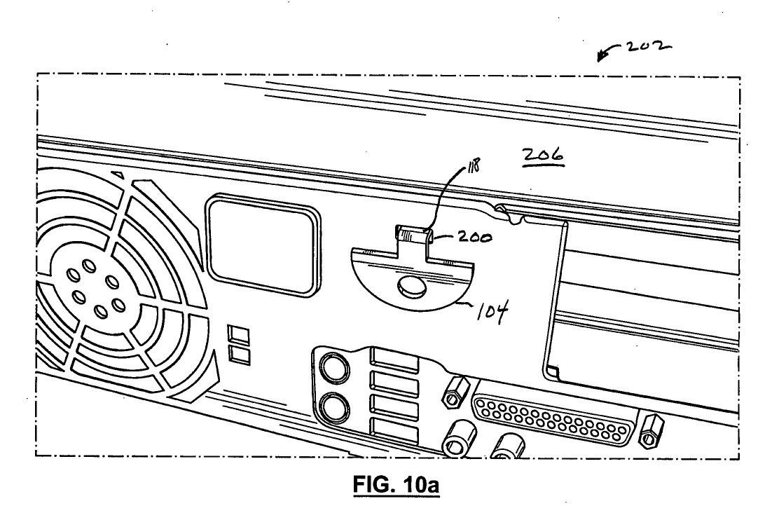

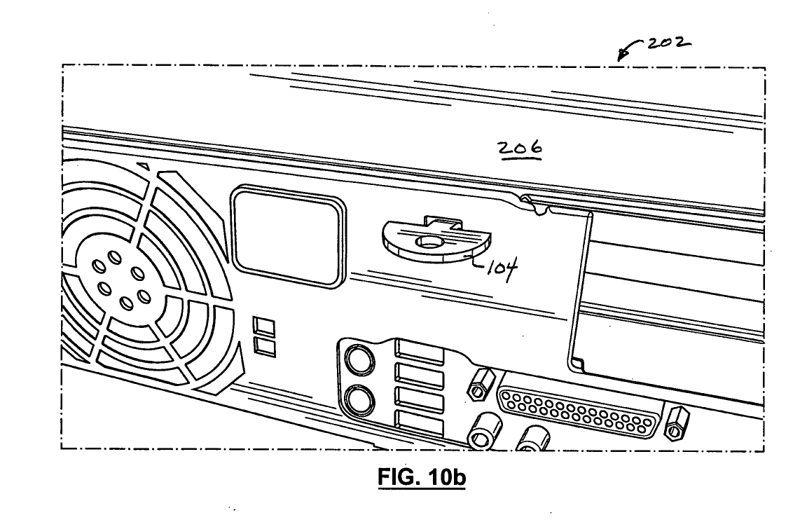

Reference is now made to FIGS. 7, 8, and 9 in conjunction with FIG. 6. FIG. 7 shows a perspective view of the rearward end of the locking mechanism 212 resting in the unlocked position described with reference to FIG. 6. As seen in FIG. 7, the push rod 214 rests in the rearwardly biased position, due to the biasing spring 222. In this rearward position, the actuating end 216 of the push rod 214 abuts against a clip 230 that has a receiving slot 232 (shown in FIG. 8) that is aligned with the security slot 200 when the releasable cover 206 is in the closed position. Together, the clip 230, the receiving slot 232, and the security slot 200 form a socket 233, with the actuating end 216 resting at an end portion of the socket 233. FIG. 8 shows a perspective view of the rearward end of the locking mechanism 212 disposed in a forward, locked position. In the locked position (i.e., when the releasable cover 206 is in the closed position and the office equipment security device 100 is in place in the security slot 200 and occupies the socket 233, as described above), the end 112 of the first key 102 extends through the slots 200 and 232 and abuts against the actuating end 216 of the push rod 214, thereby retaining the push rod 214 in the forward, locked position. When in the forward, locked position, the push rod 214 lies between the transverse pushrod engaging members 226 and the side portions 220 of the push rod 214 abut against the ends of the transverse pushrod engaging members 226, thereby preventing the buttons 208 from being depressed and the releasable cover 206 from being opened. FIG. 9 shows a perspective view of a receiving slot 232 located at a front end 234 of the main chassis 204. The receiving slot 232 receives the raised end 218 of the push rod 214 when the push rod 214 is in its forward, locked position, as described above. The receiving slot 232 additionally serves to lock the releasable cover 206 in the closed position, so that even if one were to succeed in depressing the buttons 208 when the push rod 214 is in its forward, locked position (e.g., by using excessive force to break the transverse push rod engaging members 226), the releasable cover 206 still cannot be lifted into the open position because of the engagement between the raised end 218 and the receiving slot 232.

FIGS. 5-9 illustrate but one example of a possible locking mechanism that may be used in conjunction with the security slot 200 and the office equipment security device 100. It will be understood by those skilled in the art that any number of locking mechanisms can be designed to take advantage of the configurations of the different embodiments of the security device 100, according to the design criteria of a particular application.

Reference is now made to FIGS. 10a-e, which show in perspective view a series of steps of installing the office equipment security device 100. In a first step, as shown in FIG. 10a, the end 120 of the second key 104 is placed in the security slot 200, with the head portion 114 oriented in a downward position. As shown in FIG. 10b, the body portion 118 of the second key 104 is fully inserted into the security slot 200, which involves rotating the second key 104 upwards, such that the second key 104 comes to rest with the head portion 114 resting in a plane parallel with the releasable cover 206 (when in its closed position) and the body portion 118 points downwards inside the personal computer 202. Next, as shown in FIG. 10c, the end 112 of the first key 102 is inserted into the security slot 200, above the second key 104. Next, as shown in FIG. 10d, the first key 102 is advanced until substantially the entire body portion 110 of the first key 102 extends through the security slot 200 and rests inside the personal computer 202. If the personal computer 202 is equipped with a locking mechanism, such as was described in relation to FIGS. 5-9, one or both of the body portions 110 and 118 occupy the socket 133 and the personal computer 202 is prevented from being opened when the keys 102 and 104 are in position, as shown in FIG. 10d. Finally, since the holes 108 and 116 are now in alignment, a shackle of a padlock 236 may be inserted through the holes 108 and 116 to secure the head portions 106 and 114 together, as shown in FIG. 10e. The bent body portion 118 of the second key 104 (i.e., the angle 122, which is 90 degrees in the current example) prevents the keys 102 and 104 from being removed from the security slot 200 when locked in place by padlock 236, as shown in FIG. 10e. The ends of a chain or steel cable 238, or other device may also be placed through the shackle of the padlock 236 and suitably routed around a desk leg or other secure fixture so as to anchor the personal computer 202 in place.

One advantage of the office equipment security device 100 is that the body portions 110 and 118 may provide for a significant amount of contact (e.g., surface area) with the inside of the computer 202 or electronic device in which the security device 100 is installed. This is particularly true when one or both of the angles 113 and 122 is substantially 90 degrees, thereby making it very difficult to forcibly remove the security device 100 without unlocking the padlock 236.

While the present invention is described, by way of example, in the context of office equipment and a microcomputer device, it will be understood by those skilled in the art that the office equipment security device 100 is equally applicable to any piece of electronic equipment having a security slot 200, including personal computers, laptops, monitors, portable storage devices, fax machines, photocopiers, printers, scanners, portable music players, personal digital assistants, cellular phones, telephones, televisions, stereos, DVD players, VCRs, etc.

The present invention may be embodied in other specific forms without departing from the spirit or essential characteristics thereof. Certain adaptations and modifications of the invention will be apparent to those skilled in the art. Therefore, the presently discussed embodiments are considered to be illustrative and not restrictive, the scope of the invention being indicated by the appended claims rather than the foregoing description, and all changes which come within the meaning and range of equivalency of the claims are therefore intended to be embraced therein.

What is claimed is:

1. A security device for use with an electronic device and a lock, the electronic device having a security slot, the security device comprising:
a first key having a body portion and a head portion; and
a second key having a body portion and a head portion, the body portion of the second key being disposed at an angle relative to the head portion of the second key,
wherein the body portions of the first key and the second key can be extended through the security slot and the first head portion and the second head portion can be secured together with the lock such that the body portions of the first key and the second key within the electronic device diverge to preclude withdrawal of the bodies from the slot.

2. The security device according to claim 1, further comprising:
a hole located in the head portion of the first key sized for receiving a shackle of the lock; and
a hole located in the head portion of the second key sized for receiving the shackle of the lock.

3. The security device according to claim 2, wherein the heads of the first key and the second key are substantially identical such that when the head of the first key is placed on top of the head of the second key, with the heads in substantial alignment, the holes are also in substantial alignment.

4. The security device according to claim 2, wherein the head portion of the first key is wider than the body portion of the first key and the head portion of the second key is wider than the body portion of the second key.

5. The security device according to claim 4, wherein:
the head portions of the first and second keys are semi-circular in shape;
the body portions of the first and second keys are rectangular in shape; and
the body portion of the first key attaches to a center of a straight diameter portion of the semi-circular head portion of the first key and the body portion of the second key attaches to a center of a straight diameter portion of the semi-circular head portion of the second key.

6. The security device according to claim 2, wherein the angle is between 170 degrees and 75 degrees.

7. The security device according to claim 2, wherein the angle is substantially 90 degrees.

8. The security device according to claim 3, wherein a collective cross-sectional dimension of the body portions of the first key and the second key is sized to be less than or equal to the size of the security slot in the electronic device.

9. The security device according to claim 8, wherein the dimension is approximately 0.125 (+/−0.01)×0.275 (+/−0.01) inches.

10. The security device according to claim 1, wherein the body portion of the first key is bent at an angle relative to the head portion of the first key.

11. The security device according to claim 1, wherein the body portion of the first key is long enough to actuate a locking mechanism of the electronic device when inserted into the electronic device through the security slot.

12. An electronic device security device for use with an electronic device and a lock, the electronic device having a housing, the housing having a security hole formed therein, and the electronic device further having a locking mechanism defining a socket and preventing the electronic device from being opened when the socket is occupied, the electronic device security device comprising:
a first key having a body portion and a head portion, the body portion being disposed at a first angle relative to the head portion; and
a second key having a body portion and a head portion, the body portion being disposed at a second angle relative to the head portion,
wherein at least one of the first angle and the second angle is less than 180 degrees; and
wherein the body portions of the first key and the second key can be extended through the security hole to occupy the socket and the first head portion and the second head portion can be secured together with the lock such that the body portions of the first key and the second key within the electronic device diverge due to the first angle and the second angle to preclude withdrawal of the body portions from the hole.

13. The electronic device security device according to claim 12, further comprising:
a hole located in the head portion of the first key sized for receiving a shackle of the lock; and
a hole located in the head portion of the second key sized for receiving the shackle of the lock.

14. The electronic device security device according to claim 13, wherein the heads of the first key and the second key are substantially identical such that when the head of the first key is placed on top of the head of the second key with the heads in substantial alignment, the holes are also in substantial alignment.

15. The electronic device security device according to claim 13, wherein the head portion of the first key is wider than the body portion of the first key and the head portion of the second key is wider than the body portion of the second key.

16. The electronic device security device according to claim 13, wherein the first angle and the second angle are each between 180 degrees and 75 degrees, but the first angle and the second angle are not both 180 degrees.

17. The electronic device security device according to claim 13, wherein the first angle is between 180 degrees and 75 degrees and the second angle is between 160 degrees and 75 degrees.

18. The electronic device security device according to claim 13, wherein the security hole is a security slot.

19. A security device for use with an electronic device and a lock, the electronic device having a security slot, the security device comprising:
a first key having a body portion and a head portion, the body portion of the first key being disposed at a first angle relative to the head portion of the first key, the first key further having a hole located in the head portion sized for receiving a shackle of the lock; and
a second key having a body portion and a head portion, the body portion of the second key being disposed at a second angle relative to the head portion of the second key, the second key further having a hole located in the head portion sized for receiving the shackle of the lock,
wherein at least one of the first angle and the second angle is less than 180 degrees; and
wherein the body portions of the first key and the second key can be inserted into the security slot and the shackle can be passed through the holes in the head portions to secure same together such that the body portions of the first key and the second key within the electronic device diverge due to the angles to preclude withdrawal of the bodies from the slot.

20. The security device according to claim 19 in combination with a computer having the security slot wherein the body portions of the first key and the second key are disposed in the security slot and the shackle passes through the holes in the head portions to secure same together such that the body portions of the first key and the second key within the computer diverge due to the angles to preclude withdrawal of the bodies from the slot.

21. A method for using the device according to claim 19 to secure the electronic device comprising the steps of:
inserting the second key into the security slot;
inserting the first key into the security slot; and
securing the first head portion and the second head portion together with the lock.

22. An office device having a security slot through a panel thereof and a security device, the security device comprising:
a first key having a body portion and a head portion; and
a second key having a body portion and a head portion, the body portion of the second key being disposed at an angle relative to the head portion of the second key,
wherein the body portions of the first key and the second key are disposed in the security slot and the head portions are secured together using a lock so that the keys cannot be withdrawn from the slot.
